(19) United States
(12) Patent Application Publication
(10) Pub. No.: US 2006/0167715 A1
(43) Pub. Date: Jul. 27, 2006

(54) Method and a corresponding system for creativity and innovation management

(76) Inventor: Gil Thieberger, Kiryat Tivon (IL)

Correspondence Address: Active Knowledge Ltd, POB 294, Kiryat Tivon, 36010, IL

(21) Appl. No.: 11/335,539

(22) Filed: Jan. 20, 2006

Related U.S. Application Data
(60) Provisional application No. 60/645,109, filed on Jan. 21, 2005.

(51) Int. Cl. G06Q 99/00

(52) U.S. Cl. 705/1

(57) ABSTRACT

A methods and a corresponding systems for creation, sharing, disseminating, gathering, tracking, developing, archiving, and managing of information regarding: business goals, creative ideas in coherence with specific business goals, and implementations of these creative ideas. The first preferred main step is propagating required goals from predefined decision makers to predefined employees. The second preferred main step is helping the entrepreneurs with executing, developing and maintaining the creative idea and/or its outputs.

This application claims the benefit of U.S. Provisional Patent Application No. 60/645,109, filed Jan. 21, 2005, which is hereby incorporated by reference in its entirety.

### FIELD AND BACKGROUND OF THE INVENTION

The present invention relates to a novel structured creative ideas management, and more particularly, to methods and a corresponding systems for creation, sharing, disseminating, gathering, tracking, developing, archiving, and managing information as regards business goals, creative ideas aligned with specific business goals, and implementation of these creative ideas.

Basic principles and details relating to either methods of creative ideas management and/or the conversion of creative ideas into enabled innovations, needed for properly understanding the present invention are provided herein. Additional theoretical descriptions, details, explanations, examples, and applications of related prior art subjects are readily available in standard references from the following fields: innovativeness, creativity, portfolio management, intellectual capital management, intellectual assets management, intellectual property management, knowledge management, and data processing.

In the case of intellectual property, typically, the process of converting creative ideas into enabled innovations has been done manually, i.e., an inventor invents an invention or thinks about a creative idea. The inventor discusses the invention or the creative idea with an intellectual property (IP) manager or some other manager in his organization. The IP, or other, manager, guides the inventor in accomplishing the required disclosure, validates the invention, or the creative idea, according to his own criteria and may be assisted in validating by people he knows. The disclosure is forwarded to a patent attorney who interviews the inventor and writes up the patent application. In the case of a non-patentable creative idea, the organization may or may not have a process for corroborating the business advantages of the creative idea. In the case of a patentable invention, the patent application is filed by the patent attorney and relevant communications are forwarded to the IP manager. Depending on the organization, there may be cases wherein either before or after the filing of the patent application, a patentability search is conducted in order to validate the patentability of the invention and freedom to operate issues.

Thus, the ability to cooperate and obtain feedback from different users, used in correcting and enhancing the IP development process, is very limited and based upon the limited variety of techniques taught by experienced practitioners. Therefore, a systematic approach to intellectual assets management is needed for providing a consistent and reliable means for rapid conversion of creative ideas into enabled innovations, and for training others to do the same.

Prior art systems for filing invention disclosure enable the inventor both to describe his invention and to send the disclosure to addition people for review and further work on the process of the application filing. In U.S. Pat. No. 5,247,661, issued to Hager, et al, there is disclosed a method and apparatus for automated document distribution in a data processing system. In U.S. Pat. No. 6,654,767, issued to McAnaney, et al, there is disclosed a methods and system for management of invention disclosures. The system restricts access by users, based upon job description, and facilitates the evaluation of each invention disclosure.

However, prior art systems, are notably limited because they do not provide the user with information such as: What should he perform within a given step? Why should he do it? How should he do it? How should the work in this step be measured? And what are the available feedbacks? Moreover, prior art systems for filing invention disclosure distribute the invention disclosure files to one or more skilled evaluators for appraisal, wherein the skilled evaluators are selected by their technical background and not by their connection to the business objects that the specific invention disclosure gives answer to.

In addition, prior art docketing systems, search tools and other computer tools typically do not provide any substantive or procedural guidance or any business input to the system users regarding the business goals that are to be supported by the creative idea and/or invention. Moreover, prior art tools, such as patent-oriented tools, general IP-oriented tools and “to do list” tools, do not provide much in terms of an overview of related business goals, information such as relationships between the business goals and the required creative ideas, or products or strategies of the business enterprise, but rather focuses upon statements of work or legal issues required for obtaining a patent protection. Furthermore, when dealing with the integration of IP within the business activities of the organization, prior art tools are of limited usefulness to an IP portfolio manager whose primary responsibility is screening and maintaining the patent portfolio in order to maximize profits.

Moreover, prior art systems do not, and obviously are not extendable to provide the managers of the organization a structured process for propagating the business goals down through the organization. In other words, prior art systems do not provide means for aligning the individuals with the business goals and the business requirements.

To date, the inventor is unaware of any prior art teaching of a method and a corresponding system for rapid conversion of creative ideas into enabled innovations, featuring a predefined process, focused instructions, document management, and a process control mechanism.

To one of ordinary skill in the art, it would be highly advantageous to have, both the methods and a corresponding systems, for aligning the individuals with the business goals and the business requirements.

It is also desirable to have methods and a corresponding systems for rapid conversion of creative ideas into enabled innovations, featuring a predefined process, focused instructions, document management, and a process control mechanism.

Furthermore, it is desirable to have methods and a corresponding systems for providing various managers in a business organization whose business goals are at least in part based upon the business goals of their manager or managers, to share business goals information, collaborate in the creation of detailed business goals and related documents, and to streamline the flow of such information from the creation of the business goals and other documents to the users who have to act in accordance with it. Moreover, it is also desirable to relate various types of business goals in such a manner that enhances its usefulness to such users and the organization.

Moreover, it is desirable to have methods and a corresponding systems for making available predefined business goals to various users in a business organization, whose decisions and activities are based upon those business goals and related information.

Moreover, it is desirable to have methods and a corresponding systems for enabling users in a business organization to collaborate on activities and interpretations related to predefined business goals and related documents, and to streamline the flow of such activities and interpretations related to predefined business goals from the initiation of a solution for a business goal or a related document through all the required parts of the enabling process.

Moreover, it is desirable to have methods and a corresponding systems for aggregating various types of activities and interpretations related to predefined business goals in a manner that enhances its usefulness to such individuals and the organization.

Moreover, it is desirable to have methods and a corresponding systems for reducing the time that managers spend on connecting various business activities to business goals, and to other business activities, a well.

Moreover, it is desirable to have methods and a corresponding systems for identifying ideas worth pursuing.

Moreover, it is desirable to have methods and a corresponding systems for supporting decisions related to innovation issues, whereby those decisions can be made more easily.

Moreover, it is desirable to have methods and a corresponding systems for providing the user with information on what is one to do within a specific step?

Moreover, it is desirable to have methods and a corresponding systems for providing the user with information regarding why should one do what one does within each step?

Moreover, it is desirable to have methods and a corresponding systems for providing the user with information regarding how to do what one has to do within each step?

Moreover, it is desirable to have methods and a corresponding systems for providing the user with information regarding how the work in each step will be measured?

Moreover, it is desirable to have methods and a corresponding systems for providing the user with information regarding the available feedbacks one should and can receive.

### SUMMARY OF THE INVENTION

The present invention relates to a novel structured creative ideas management, and more particularly, to methods and a corresponding systems for creation, sharing, disseminating, gathering, tracking, developing, archiving, and managing information as regards business goals, creative ideas aligned with specific business goals, and implementation of these creative ideas.

The present invention is primarily directed toward applications of innovation, innovation process enhancement, intellectual property (IP) enhancement, IP development, IP maintenance, and IP management. However, the present invention clearly can be directed to applications of: portfolio development, IP portfolio management, IP portfolio maintenance, and projects portfolio management in various other fields, including systems engineering, knowledge management, business process management, innovation management, business technology management, end-to-end processes management system, project portfolio, risk management, financial management, human resources management, and any other organizational horizontal and vertical activities that require input from a plurality of functions within the organization, and optionally from outside the organization, as well.

Hereinafter, the term “computer” refers to any electronic device or system that is able to communicate with a user and save data, including, but not limited to personal computers, workstation, Personal Digital Assistant (PDA), terminal, server, network computer, or user input/output unit.

Hereinafter, the term “enabled innovation” refers to any outcome that has a clear benefit, including, but not limited to innovative product, innovative method, innovative process, innovative service, innovative plan, innovative transaction, innovative business solution, business opportunity, new business ideas, risk control and reduction, and new proposals.

Hereinafter, the term “document” includes any information stored electronically, such as electronic document, form, data base, tree, record, folder, link, etc.

Hereinafter, the term “invention” is not intended to imply any legal conclusion, but rather refers more generally to a creative idea, or information disclosure or a solution to a problem/need that is believed to be new.

Hereinafter, the term “entrepreneur” refers to any user of the system and/or method of the present invention, or individual or a group of individuals that think about a creative idea or helping to execute the creative idea. In the case of a patent application, the entrepreneur may also be an inventor.

The present invention for a method and corresponding system for rapid conversion of creative ideas into enabled innovations, features a predefined process, focused instructions, document management, and a process control mechanism that successfully addresses limitations of presently-known methods and systems for conversion of creative ideas into enabled innovations and especially for information-disclosure retrieval and IP processing.

The present invention enables overcoming the gap between the requirements of the business goals and the activities of the users of the present invention. In other words, overcoming the problem of one not being aware of the up-to-date business goals of the organization when one submits an invention.

The present invention enables the users to control the method for managing the innovations and IP of the organization, not only with regard to the legal aspects, but also with regard to the full range of aspects/issues related to content.

The present invention successfully addresses shortcomings and limitations of presently known methods for IP management more rapidly, by having a built-in feedback mechanism for retrieving information from additional sources, thanking more considerations efficiently, and therefore, is more cost effective, than other techniques for IP management and rapid conversion of creative ideas into enabled innovations, under current use. The system of the present invention can be readily implemented using standard hardware and software configurations. Moreover, the system of the present invention is generally applicable as a ‘stand-alone’ system, or, as a system used in combination with other methods, devices, and systems, performing management, planning and controlling functions for the organization.

Implementation of the method and corresponding system for rapid conversion of creative ideas into enabled innovations of the present invention involves performing or completing selected tasks or steps manually, semi-automatically, fully automatically, and/or, in a combination thereof. Moreover, depending upon actual instrumentation and/or equipment used for implementing a particular preferred embodiment of the disclosed system and corresponding method, several embodiments of the present invention could be achieved by hardware, by software, by firmware, or a combination thereof. In particular, with hardware, embodiments of the invention could exist by variations in the physical structure. Additionally, or alternatively, with software, selected functions of the invention could be performed by a data processor, such as a computing platform, executing a of computer program types of software instructions or protocols using any suitable computer operating system.

### BRIEF DESCRIPTION OF THE DRAWINGS

The present invention is herein described, by way of example only, with reference to the accompanying drawings. With specific reference now to the drawings in detail, it is stressed that the particulars herein shown are by way of example and for purposes of illustrative discussion of the preferred embodiments of the present invention only. Moreover, they are presented in order to provide what is believed to be the most useful and readily understood description of the principles and conceptual aspects of the present invention. In this regard, no attempt is made to show structural details of the present invention in more detail than is necessary for a fundamental understanding of the invention, the description taken with the drawings making apparent to those skilled in the art how the several forms of the invention may be embodied in practice. Identical structures, elements or parts which appear in more than one figure are preferably labeled with a same or similar number in all the figures in which they appear. In the drawings:

FIG. 1 is a flow diagram of an exemplary model in accordance with the present invention;

FIG. 2 is a schematic diagram illustrating the connectivity to the business goals, in accordance with the present invention;

FIG. 3 is a schematic diagram illustrating the business goals propagation, in accordance with the present invention;

FIG. 4 is a flow diagram of an exemplary model in accordance with the present invention; and

FIG. 5 is a schematic diagram illustrating an exemplary architecture, in accordance with the present invention;

### DESCRIPTION OF THE PREFERRED EMBODIMENTS

The present invention relates to a novel methods and a corresponding systems for creation, sharing, disseminating, gathering, tracking, developing, archiving, and managing information as regards business goals, creative ideas aligned with specific business goals, implementation of these creative ideas, and other.

The method and corresponding system for rapid conversion of creative ideas into enabled innovations of the present invention is based on the novel and unique innovation method, which features a set of steps; defining the required information and knowledge at each step, providing a user the required information and knowledge at each step; processing the user input, and providing a mechanism to control the innovation method. A main aspect of novelty and inventiveness of the present invention is its ability to control the innovation process and to align the users to the required goals. Exemplary goals may be, but not limited to, business goals, technical goals, marketing goals, operational goals, and/or cultural goals. The ability to control the innovation and to align the users with the required goals strongly contrasts with prior art methods and systems that do not provide the novel innovation method, nor do they provide to a user the required information, knowledge and required goals at each step. Moreover, prior art methods and systems do not provide a process control mechanism which is simple, easy to work with, and intuitive.

Today, knowledge-based organizations need to update and/or change their business goals, products, processes and services within short time frames. Therefore, knowledge-based organizations must be able to manage their knowledge and intellectual assets, and especially their intellectual property (IP), in addition to managing the following activities: business, operations, development and finance. It is to be noted that the scope of each business goal depends on its location in the corporate structure. For example, business goals in an engineering department usually include technical requirements while business goals in a marketing department will usually include customer related requirements. Exemplary business goals including, but not limited to, marketing-related goals, technical-related goals, operational-related goals, financial-related goals, human-related goals, intellectual capital goals, business objects, etc.

In order to solve these intellectual asset management problems, which nowadays are faced by most knowledge-based companies, two preferred main steps are necessary: The first preferred main step is propagating required goals, from predefined decision makers to predefined users. The first preferred main step enables users to define and understand what are the organization's needs and/or what the organization requires from them, and/or why must they think about creative ideas, and/or how their creative ideas would be measured and evaluated. Moreover, the first preferred main step enables the organization to better understand, manage, align, translate, measure and control its business goals. The second preferred main step is processing creative ideas. The second preferred main step is helping the entrepreneurs with executing, developing and maintaining the creative idea and/or its outputs.

In an exemplary embodiment of the present invention, the first preferred main step is propagating the required innovations and required issues to compose corresponding patents, throughout the organization. The second preferred main step is collecting information disclosures, screening the inventions, submitting patent applications on selected inventions and maintaining the patents portfolio as known in the art, as well as with the novel additions disclosed in the present invention.

A general aspect of novelty and inventiveness of the present invention is the integration between the system for propagating the required business goals and the system for processing the creative ideas. This integrated system is in strong contrast with prior art systems that are focused on translating strategy into actions or organization alignment, or systems that are focused on processing invention and/or IP maintenance. Prior art systems are completely different, and neither could speak the other's language. For example, prior art system for processing invention disclosures are not connected to prior art systems that translate strategy into operational terms. As a result, invention disclosures are usually not screened by using criterions taken from the required business goals, but by static criterions such as novelty and inventive step criterions.

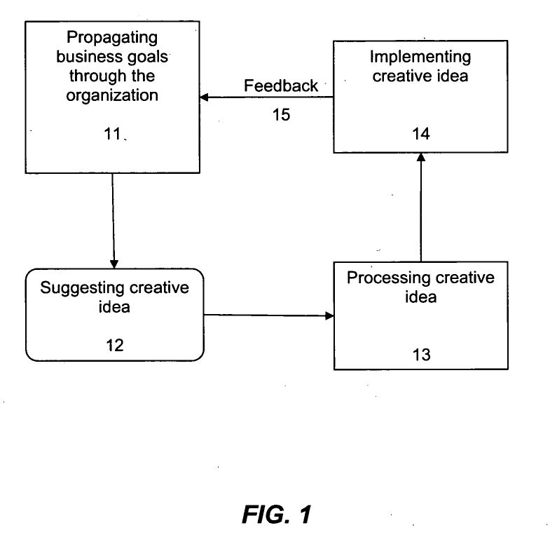

FIG. 1 illustrates a general aspect of novelty and inventiveness in the preferred embodiment of the method and a corresponding system for the rapid conversion of creative ideas into enabled innovations. As illustrated in FIG. 1, the two preferred main steps are: (1) Propagating required business goals 11 from predefined decision makers to predefined users. Or in other words, downloading goals from decision makers, all the way down to employees. As a result of understanding the requirements (i.e. what to do), entrepreneurs suggest creative ideas 12. (2) Processing creative ideas 13 by screening, improving, boosting, and maintaining creative ideas and inventions aligned with the required goals. Or in other words, flooding up creative ideas and inventions from users up to the decision makers in order to convert the creative ideas to enabled innovations. In an embodiment option of the present invention, the processing of creative ideas is linked with the required business goals so that whenever the business goals change, the creative ideas may be updated and/or the processing of the creative ideas may be updated. The implementation of creative idea 14 may be done according to any known in the art method. Feedback 15 may be derived from the implementation of creative idea 14 or from the market, and is used for updating and adjusting the business goals or the business goals propagation process. It is to be understood that the predefined decision makers may be users of the present invention.

Optionally, the management and maintenance of the IP portfolio is aligned with the business goals too, as disclosed in the preferred embodiment of the present invention.

The first main step of propagating business goals from the decision makers to the predefined users is required mainly in order to explain to the users what the needs of the company are. In an embodiment option of the present invention, the required goals are business goals. By being aware of the needs of the company, the users are able to focus their inventive and creative thinking on fields/areas in which the company has a business interest. Moreover, after understanding the business goals, the users better understand their tasks and the problems they are dealing with, or, are supposed to deal with; This improved understanding enables the users to focus their thoughts on more valuable business opportunities.

The second main step of processing creative ideas, i.e. screening, improving, and boosting creative ideas and inventions, which are aligned with the required goals, is required mainly for increasing the number of relevant creative ideas, increasing the quality of the ideas being developed, decreasing time to accomplish, decreasing costs, assessing the risks and rewards, comparing the assessment to a baseline of proven successful enabled innovations, and providing insight into what the next step should be. Moreover, this step invites more effective planning, improved commitment, improved resources allocation, and overall planning for innovation enhancement. Understanding the process of ideas evaluation significantly increases the ability to improve the process as well as raising employee motivation levels.

The above described two main steps promote more innovation, as inventors can better understand what kind of creative ideas are welcome? where their creative ideas end up? and, how their ideas develop?

It has been observed by the inventor that, typically, IP portfolio development and management is substantially influenced by the following three factors: personal experience, technical understanding, and working style of the IP portfolio manager. Moreover, the inventor has observed that personal influence causes variations in the quality and performance of the process. By using the method and corresponding system of the present invention, IP portfolio development and management is less sensitive to the above described effects of personal influence. The results reflect better performance, and a more accurate and reliable method and system for rapid conversion of creative ideas into enabled innovations.

The present invention is a method and corresponding system for rapid conversion of creative ideas into enabled innovations. The preferred embodiments of the present invention are discussed in detail below. It is to be understood that the present invention is not limited in its application to the details of the order or sequence of steps of operation or implementation of the method and the details of construction, arrangement, and, composition of the components of the system set forth in the following description, drawings, or examples. While specific steps, configurations and arrangements are discussed, it is to be understood that this is done for illustrative purposes only. A person skilled in the relevant art will recognize that other steps, configurations and arrangements can be used without departing from the spirit and scope of the present invention.

Additionally, for better understanding the overall general method of the present invention, the description provided herein details an IP-related method and corresponding system, however, it is to be clearly understood that the overall general method of the present invention is extendable and applicable to almost any creative ideas development and management, as well as to general management of a variety of operations.

The present invention is capable of other embodiments or of being practiced or carried out in various ways. Also, it is to be understood that the phraseology, terminology, and notations, employed herein are for the purpose of description and should not be regarded as limiting.

Steps, components, operations, and implementation of rapid conversion of creative ideas into enabled innovations, according to the present invention are better understood with reference to the following description and accompanying drawings.

In the following description of the method of the present invention, included are only main or principal steps needed for sufficiently understanding proper ‘enabling’ utilization and implementation of the disclosed methods and a corresponding systems for creativity and innovation management. Accordingly, descriptions of the various required, or optional minor, intermediate, and/or, sub-steps, which are readily known by one of ordinary skill in the art, and/or, which are available in the prior art and technical literature relating to [field of invention], are not included herein.

The first preferred embodiments of the methods and corresponding systems for managing creative ideas are herein described.

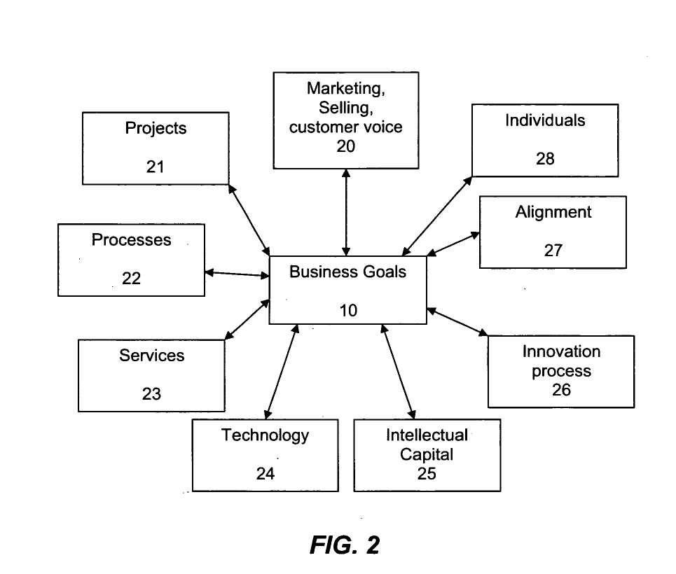

FIG. 2 illustrates various exemplary activities (20-28) that are influenced by business goals 10 and/or are influencing the business goals. Each exemplary activity may be linked to the other exemplary activities directly (not shown in the figure) or through business goals 10. It is to be understood that the various activities that are influenced by business goals 10 and/or are influencing the business goals in accordance with the present invention are easily scaleable through the addition of other activities and/or the subtraction of various activities. Moreover, it is to be understood that intellectual capital 25 includes human capital and intellectual assets. Wherein intellectual assets include intellectual property. Intellectual property includes all things related to patents, trademark, copyright registrations, nondisclosure agreements and licenses.

As will become more apparent from the descriptions below, the method and corresponding system of the present invention is goal-driven or invention-driven, in the sense that a document describing a business goal or a document describing an invention may become the basis for further actions.

Introducing at least one business goal.

In an embodiment option of the present invention, the business goals are a result of the vision, mission and strategy.

The business goals used in the present invention my be produced by well known in the art methods. For example: alignment techniques, balanced scorecard methods, management by objectives, etc.

Providing various users with a framework to share business goals information.

The present invention enables its users to share business goals with other users, or groups, as orders (downloading from the top); or by providing/sending feedback (uploading a comment, feedback, request or suggestion).

Users may share business goals information with other users designated to act and/or to decide in accordance with the business goals.

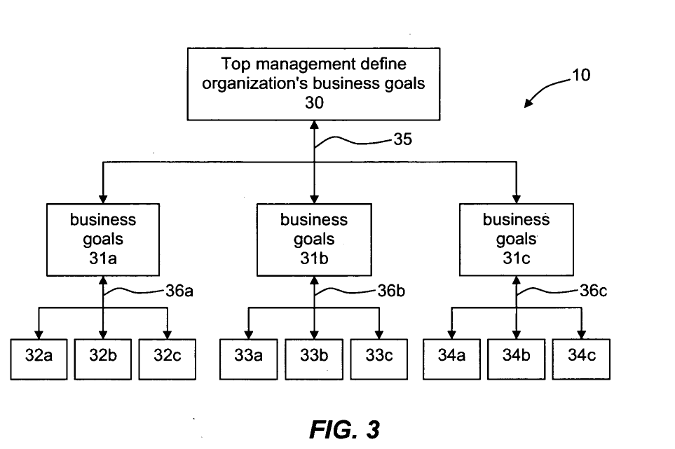

FIG. 3, illustrates an exemplary method for propagating business goals 10 through the management layers of an organization. Users who have a stake in defining and interpreting the business goals (business goals stakeholders), such as, but not limited to, managers, directors, and investors, can electronically create, store and share the use of information and documents in a database or similar repository. Documents relating to different business goals, such as business goals at different layers, for example 30, 31a, and 32a, or at the same layer, such as 31a, 31b, 31c, can be linked or grouped together. An exemplary link is a cause and effect relationship. Alternatively, documents relating to different business goals can be linked or grouped together under a common requirement or need, to which they relate.

In an embodiment option of the present invention, relevant information is introduced to the users using searching capabilities, a decision support system, and/or an expert system.

In an embodiment option of the present invention, business goals 10 are stored in a manner that makes them electronically accessible to, and shareable among, stakeholders of the organization having the appropriate authorization.

Each business goals document, such as 30, 31a-c, 32a-c, 33a-c, 34a-c, etc., can be linked to any other business goal document. In an embodiment option of the present invention, links between different documents are accomplished using hypertext, addresses, tables, or any of a variety of similarly well-known linking concepts commonly used in information systems. FIG. 3, illustrates a hierarchical linking graph wherein each business goal is linked to its parent and children requirement, for example, a division business goal and to its children, for example, departments business goals. Moreover, the linking enables, for example, a manager owning a parent business goal, to review its children business goals and to correct or provide feedback whenever needed.

It is to be understood that FIG. 3 illustrates only an exemplary hierarchy in accordance with the present invention and can be easily scaleable through duplications of its layers.

In an embodiment option of the present invention, the business goals may provide the user with answers to the following question: What innovation is required by the organization?; What innovation would help the organization?; or What innovation is unneeded?

Moreover, business goals may provide the user with information regarding Why should the user do what he does within each step?

Moreover, business goals may provide the user with information regarding How to do what he has to do within each step?

Moreover, business goals may provide the user with information regarding How the work in each step will be measured?

Moreover, business goals may provide the user with information regarding the available feedbacks he should and may receive.

Referring again to FIG. 2, following the links enables a manager, according to his authorization, to review and optionally edit other related materials and documents related to a certain business goal, including, but not limited to, marketing, selling and customer voice documents 20, projects 21, processes 22, services 23, technology 24, intellectual capital 25, innovation process 26, alignment 27, and individuals 28. Similarly, any stakeholder of a business goal can follow links related to a specific business goal in order to get a better understanding of the requirements and needs, and the related activities in the organization.

Optionally, providing a collaborative ability in creating, phrasing and rephrasing of detailed business goals and related documents.

The collaborative ability streamlines the flow of such information from the creation of the business goals and other documents to the users having to act in accordance with it.

In an embodiment option of the present invention, the collaborative ability, in creating and phrasing of detailed business goals and related documents, between the owner of the business goal and users who should act in accordance with the business goal, features a feedback mechanism. The feedback mechanism enables the users to express their understanding and interpretation of the business goal. Moreover, this feedback mechanism enables the business owner to better understand his own needs and the quality and clarity of his business goal phrasing. Referring to FIG. 3, links 35, and 36a-c are bi-directional links, enabling each manager owning a child goal to signal or communicate with the manager owning its parent goal about his status, understandings and interpretations.

In another embodiment option of the present invention, the collaborative ability, in creating and phrasing of detailed business goal and related documents, between an owner of an business goal and his manager, features a feedback mechanism, enabling the owner of the business goal to express his understanding and interpretation regarding the requirements from him. Moreover, the feedback mechanism enables the manager of the business goal owner to better understand his own needs along with the quality and clarity of his instructions provided to the owner of the business goal. It is to be understood that the requirements from the business goal owner may be a business goal by its own.

Optionally, various types of business goals are aggregated/linked together in order to enhance their usefulness to the users and/or to the organization.

Optionally, predefined business goals are made available to predefined users.

For example, the predefined users may be employees of an organization whose decisions and activities are at least, in part, based upon the business goals, and in particular, users under the supervision of the manager that owns the predefined business goals.

Optionally, the predefined business goals are available only to users having the appropriate authorization.

Optionally, the users of the present invention collaborate on activities and interpretations related to predefined business goals.

In order to fully understand the business goals, the users may need to collaborate. This collaboration also enables the streamlining of the flow of such activities and interpretations relating to predefined business goals, from the initiation of a solution for a business goal, or to a related document, and throughout all the required parts of the enabling process.

In an embodiment option of the present invention, collaboration is used in defining the required innovation and the required intellectual property that have been, or should be, created. Optionally, the collaboration is used for IP freedom of operate activities. For example, defining the technology zones that are free to operate, defining the technology zones which have been captured and are now restricted. Moreover, an explanation regarding the restriction may be supplied.

Optionally, various types of activities and interpretations of the predefined business goals are aggregated/linked together in order to enhance their usefulness to users and to the organization.

Optionally, a mechanism identifies duplicated requirements and duplicated business goals, and takes action thereon.

The duplicated business goals and requirements identification mechanism is required for decreasing the workload associated with the building and maintenance of the business goals database. Moreover, the mechanism for identifying duplicated business goals helps in focusing the users who are working according to the business goals.

In an embodiment option of the present invention, at least one creative idea is introduced by an entrepreneur and processed by the following described steps. It is to be understood that a creative idea can originate from a variety of sources, including but not limited to: an employee, an associate, a consultant, etc. A request for a creative idea can come from an internal or external source. Moreover, the request can be made from a supplier, provider, existing customer, or new customer.

At least one creative idea is collected.

The collection of creative ideas can be performed by any known in the art method, device and/or system. Exemplary methods for collecting creative ideas are: interviewing, meeting, conferencing, debriefing, forms, contests, brainstorming, and software applications such as: portals, knowledge management applications, business intelligence applications, competitive intelligence applications, inventive thinking applications, decision-support applications, expert systems applications, etc.

In an embodiment option of the present invention, the at least one creative idea is entered into the method and corresponding system of the present invention for further processing.

Coherence between the creative idea to at least one business goal is identified.

Optionally, the identification method depends on the levels of coherence (i.e., unity/accord/relationship/connection) between the creative idea to the at least one business goal. The amount of coherence between the creative idea to the business goal may be measured or expressed qualitatively.

Optionally, the identification method uses different measurements for different business goals. For example, coherence with a productive business goal may be measured by a cost reduction measurement while a coherence with an application for a patent business goal may be measured by a cost reduction measurement and new and non-obvious.

As is written above, it is to be understood that the present invention is not limited in its application to the details of the order or sequence of steps of operation or implementation of the method and the details of construction, arrangement, and composition of the components of the system set forth in the present invention. This is especially true of the steps taken to process the creative idea. For example, in a case of an invention, the system of the present invention may first help the inventor to disclose his invention, next a quick novelty search is performed and only after, a connection to at least one business goal is applied.

In an embodiment option of the present invention, the business goals are linked to various activities in the organization. Exemplary activities in the organization are: operational activities, marketing activities, technological activities and intellectual property activities, such as patents, licenses, non-disclosure agreements and trademark registrations. The links between business goals to the various activities enable various stakeholders to remain steady with the business goals. For example, in a technical issue the stakeholders are technologists, such as scientists and engineers. Whenever the stakeholders invent inventions or think about creative ideas, they are able to check whether the inventions do or do not support the business goals. Moreover, by being aware of the various business goals, the stakeholders may be able to improve their inventions in such a way that more adequately aligns with the required business goals. In an embodiment option of the present invention, whenever the invention is supporting at least one business goal, the inventor is able to initiate a process for evaluating the invention, improving the invention, and securing the invention by filing a patent application, issuing a defensive publication, or by internal documenting.

In an embodiment option of the present invention, identifying the relevant business goal helps to identify at least one of the following: the division and/or personnel who can respond to the creative idea or audit the creative idea, the priority of the invention, the value of the invention, the target market of the invention, users of the invention, other things in the portfolio that the invention is connected to, or additional operational and financial factors that influence or are connected to the invention.

Optionally, the entrepreneur is supported when defining and exploiting the creative idea.

Optionally, there are different supporting methods for different types of creative ideas. Optionally, there are different supporting methods for different types of matched business goals. For example, a creative idea that is exploited as a patent application should be treated differently from the way a creative idea published as a defensive publication is treated.

Optionally, there are different measurements for different business goals. For example, coherence with a productive business goal may be measured by a cost reduction measurement while coherence with an application for a patent business goal may be measured by a new and non-obvious cost reduction measurement.

Optionally, the user is supported in determining the value of the opportunities that have presented themselves as a result of the creative idea.

Determining the value of the opportunities, which have presented themselves as a result of the creative idea, may be performed by a variety of known in the art methods. In an embodiment option of the present invention, the opportunity value determination method depends on the type and features of the opportunity as well as on the type and features of the creative idea.

Optionally, if the creative idea is determined to have a value below a predefined threshold, it is archived in an appropriate database, feedback is provided to the entrepreneur, and the processing of the creative idea may continue to its end. The feedback results provided to the entrepreneur may help identify/highlight why the creative idea was rejected, how it can be improved, and/or if there is a real need for improvement.

Optionally, a risk assessment of the creative idea is performed.

Risk assessment of the creative idea may be performed by a variety of known in the art methods. Exemplary criteria are: new technology, new product, new stuff, new market, new customer or existing cooperative customer, project team, time to market, available funding, customer pain, and internal processes.

Optionally, a rewards assessment of the creative idea is performed.

Rewards assessment of the creative idea may be performed by a variety of known in the art methods. Exemplary criteria are: size of the customer pain (addresses real need), sustains or grows core equity, new business development, competitive advantage, increases market size and/or share, and increases reputation, wherein the reputation can be, for example, a trademark value, professional rating, etc.

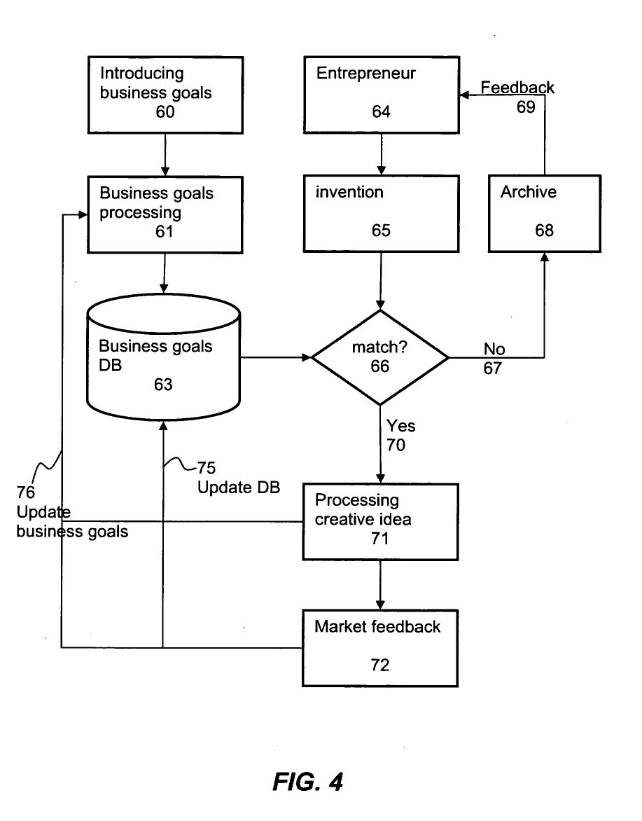

FIG. 4 is a flowchart of an exemplary method in accordance with the present invention, featuring: Introducing business goals 60, Business goals processing 61, storing in Business goals DB 63, Entrepreneur 64 introduce invention 65, if invention 65 match 66 a business goal there is processing creative idea 71, and optionally receiving market feedback 72.

It is to be understood that the present invention can be utilized within the organization by using a known in the art cooperation tools, or by third parties, such as subcontractors, public, government, customers, etc, which can use either the same or a customized user interface.

An exemplary system that provides various managers with a framework for processing business goals information toward achieving above-described objects, features: at least one stakeholder/user workstation, a network connection and server in case there is more than one workstation, and a repository in which documents are stored. The system, or at least portions of it, are located within the organization or are accessible to managers and stakeholders associated with the organization. The workstations can be located remotely in any suitable networked manner known in the art; moreover, the system can include any suitable number of such workstations.

An embodiment option of the present invention features the following software functions: search engines, a business goals generator or support means, document management or knowledge management, and authorization/access control system.

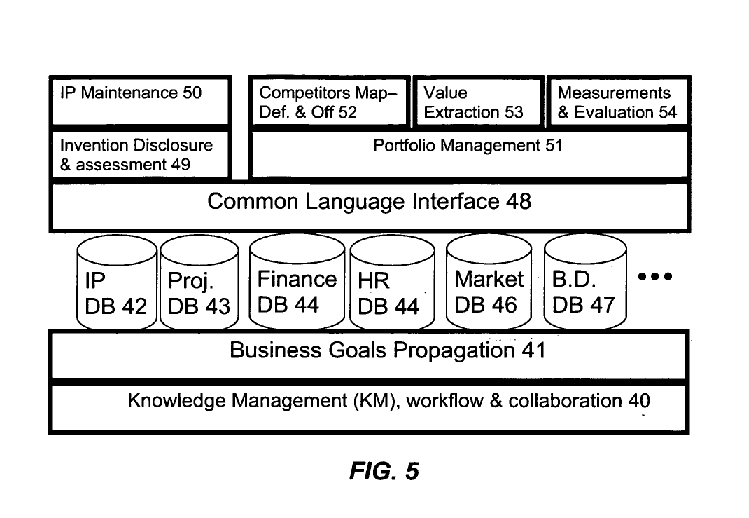

FIG. 5 illustrates an exemplary system architecture for an exemplary embodiment of the present invention. Required transactions, communications and forms are stored in a knowledge management, workflow and collaboration 40 component. In a minimal exemplary embodiment of the present invention, component 40 is replaced by a document management systems as known in the art. Business goals propagation 41 component introducing the aforementioned business goals sharing and collaborating features. The business goals are stored in a variety of databases, according to their target audience or any other criterion. It is to be understood that the various databases are only an exemplary embodiment and business goals can be stored in at least one database or with any other data storage device as known in the art. Exemplary databases (DB) are: IP DB 42, projects DB 43, finance DB 44, human resources DB 45, market DB 46, and business development DB 47.

The object of common language interface 48 is to communicate with each user in his natural language. Common language interface 48 may also be referred to as domain specific language interface. For example: requirements from engineers should be linked with their projects. When exposing engineers to patent information, they should receive just the technical parts (i.e. parts of the disclosure), and the legal parts (i.e. claims) only upon request. Marketing people usually are less concerned about deep technical product aspects, but they do require the features and specifications.

Common language interface 48 also links between various types of business goals, which in order to enhance its usefulness to users, for example, groups similar business goals. Moreover, common language interface 48 may help in identifying duplicated requirements and duplicated business goals, and taking action thereon.

In an embodiment option of the present invention, where IP management is a key issue, the following components are available:

Invention disclosure and assessment 49 component for collecting the inventions and assessing the business potential thereof. Moreover, this component may guide, support, control, and manage all the users involved, for example, in the IP processing of a patent application.

IP maintenance 50 component is used for the maintenance of the IP assets. For example, tracking important dates, connecting applications to projects/users/business goals, cost management aligned with the business value of the application, etc.

Portfolio management 51 component presents an integrated view of the IP assets of the organization and related operations such as: competitors map 52 including defense maps and offence maps, Value extraction 53 component, and measurements and evaluation 54 component.

The disclosed architecture is scalable and may incorporate additional features connected to common language interface 48, such as (not shown in FIG. 5): project management, strategy and tactics applications, customer relationship management, product life cycle management, resource planning, human resource managing, etc.

Hereinafter described exemplary methods utilizing the exemplary system architecture illustrate in FIG. 5.

Project manager is approving a change in a design review. IP maintenance 50 component is supplying information regarding the patents that are connected to the project.

Project manager is checking whether the changes influence the patents? If they do, a report is sent to the IP manager. The report may includes the following parts: change description, affected patents or patent applications, an updated opinion regarding the patent relevancy in the light of the changes, etc.

The IP manager is checking the change and is updating his IP portfolio if necessary. Moreover, the system introduces to the IP manager the patents that are associated with the entries in the database, which have been updated. The IP manager may update the patents that are connected to the specific project and to the specific patents that have been changed. The system presents to the IP manager a list of users that may be affected by the change and the IP manager is able to send them the relevant updates.

Thus, it is understood from the embodiments of the invention herein described and illustrated, above, that the method and corresponding systems for creativity and innovation management, of the present invention, are neither anticipated or obviously derived from the prior art.

It is appreciated that certain features of the invention, which, for clarity, described in the context of separate embodiments, may also be provided in combination in a single embodiment. Conversely, various features of the invention, which are, for brevity, described in the context of a single embodiment, may also be provided separately or in any suitable sub-combination.

It is to be understood that the present invention is not limited in its application to the details of the order or sequence of steps of operation or implementation of the method for creativity and innovation management or to the details of construction, arrangement, and, composition of the corresponding system thereof, set in the description, drawings, or examples of the present invention.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described in conjunction with specific embodiments and examples thereof, it is to be understood that they have been presented by way of example, and not limitation. Moreover, it is evident that many alternatives, modifications and variations will be apparent to those skilled in the art. Accordingly, it is intended to embrace all such alternatives, modifications and variations that fall within the spirit and broad scope of the appended claims and their equivalents.

What is claimed is:

1. A method comprising:
(a) introducing at least one business goal,
(b) collecting at least one invention,
(c) identifying a coherence between said invention and said business goal,
(d) processing inventions that are coherent with said business goal.

2. The method of claim 1, wherein the step of introducing at least one business goal comprising the step of propagating required goals from predefined decision makers to predefined users.

3. The method of claim 2, further comprising collaborative ability and said collaborative ability including a feedback mechanism,
Whereby said feedback mechanism enables users to express their understanding and interpretation of said at least one business goal.

4. The method of claim 1, further comprising: providing various users with a framework to share information related to said at least one business goal.

5. The method of claim 1, wherein the step of processing inventions includes:
(a) an opportunity analysis on pre-identified potential business opportunities, to determine valid business opportunities,
(b) committing resources to said valid business opportunities,
(c) developing a business proposal for said valid business opportunities,
(d) submitting said developed business proposal to a potential buyer of said valid business opportunity,
(e) determining if submission of said developed business proposal is a success,
(f) executing said business opportunity upon determining that the submission is a success.

6. The method of claim 1, wherein the step of identifying a coherence between said invention and said business goal includes:
(a) reviewing said invention for potential business opportunities by at least one predefined individual, wherein said at least one predefined individual may be selected dynamically by a predefined logic depending on the features of said invention or the matched business goal,
(b) storing said reviewing and said invention in a database for future reference.

7. The method of claim 1, wherein the step of processing inventions that are coherent with said business goal is influenced by said business goal, whereby, said processing is updated when said business goal changes.

8. The method of claim 1, wherein at least two business goals are aggregated together in order to enhance their usefulness to the users.

9. A system comprising the following components:
(a) knowledge management or document management,
(b) business goals propagation,
(c) at least one database,
(d) common language interface.

10. The system of claim 9, wherein said at least one database is selected from the group consisting of IP DB, projects DB, finance DB, human resources DB, market DB, business development DB, and combination thereof.

11. The system of claim 9, further comprising a portfolio management component.

12. The system of claim 9, further comprising an invention disclosure and assessment component.

13. An IP management method comprising:
(a) a project manager approving a change in a project,
(b) supplying information regarding patents that are connected to said project,
(c) said project manager checking whether said changes influence said patents,
(d) sending a report to said IP manager.

14. The method of claim 13, further comprising:
(a) said IP manager checking said change and updating the IP portfolio,
(b) introducing patents that are associated with the entries that have been updated,
(c) presenting a list of items that may be affected by said change.
